(19) United States
(12) Patent Application Publication
(10) Pub. No.: US 2025/0029600 A1
(43) Pub. Date: Jan. 23, 2025

(54) ELECTRONIC DEVICE INCLUDING ARTIFICIAL INTELLIGENCE AGENT AND METHOD OF OPERATING ARTIFICIAL INTELLIGENCE AGENT

(71) Applicant: Samsung Electronics Co., Ltd., Suwon-si (KR)

(72) Inventors: Taegu KIM, Suwon-si (KR); Gajin SONG, Suwon-si (KR); Hoseon SHIN, Suwon-si (KR); Jaeyung YEO, Suwon-si (KR); Eunkyung LEE, Suwon-si (KR); Hyeoncheon JO, Suwon-si (KR)

(21) Appl. No.: 18/765,110

(22) Filed: Jul. 5, 2024

Related U.S. Application Data
(63) Continuation of application No. PCT/KR2024/006314, filed on May 10, 2024.

(30) Foreign Application Priority Data
Jul. 21, 2023 (KR) 10-2023-0095618
Aug. 21, 2023 (KR) 10-2023-0109351

(51) Int. Cl. G10L 15/16; G10L 15/22

(52) U.S. Cl. CPC G10L 15/16; G10L 15/22; G10L 2015/225

(57) ABSTRACT

A device and method for operating an artificial intelligence (AI) agent in a communal space are provided. When a communal space event occurs, an AI agent that operates in common in a communal space may be generated, a domain may be determined in the AI agent, the determined domain may be loaded, user information about a user participating in the communal space event may be collected, and an utterance of the user may be processed based on the determined domain and the user information.

### CROSS-REFERENCE TO RELATED APPLICATIONS

This application is a continuation application of International Application No. PCT/KR2024/006314 designating the United States, filed on May 10, 2024, in the Korean Intellectual Property Receiving Office and claiming priority to Korean Patent Application No. 10-2023-0095618, filed on Jul. 21, 2023, and Korean Patent Application No. 10-2023-0109351, filed on Aug. 21, 2023, in the Korean Intellectual Property Office, the disclosures of which are all hereby incorporated by reference herein in their entireties.

### BACKGROUND

### 1. Field

Certain example embodiments relate to an electronic device including an artificial intelligence (AI) agent and/or a method of operating the electronic device.

### 2. Description of Related Art

In an extended reality (XR) environment, users are highly likely to perform necessary actions using voice interfaces, and utilizing voice assistants to process the actions is expected. Users can easily create spaces and invite each other to communicate. Here, if users are invited to a communal space, an issue in which all voice assistants supporting the respective users are activated and enter the communal space may occur. If voice assistants are used for each user, a voice uttered by one user in a corresponding space may be recognized and processed by a voice assistant of another user, or personal information may be indiscriminately shared, which may cause issues.

### SUMMARY

Certain example embodiments may provide a device and/or method for operating an artificial intelligence (AI).

An electronic device according to an example embodiment may include a memory, and at least one processor including processing circuitry. The processor(s) may be individually and/or collectively configured to generate an AI agent that operates in common in a communal space and determine a domain in the AI agent, when a communal space event occurs, load the determined domain, collect user information about a user participating in the communal space event, and process an utterance of the user based on the determined domain and the user information.

A method of operating an AI agent according to an example embodiment may include generating an AI agent that operates in common in a communal space, when a communal space event occurs, determining a domain in the AI agent, loading the determined domain, collecting user information about a user participating in the communal space event, and processing an utterance of the user based on the determined domain and the user information.

### BRIEF DESCRIPTION OF THE DRAWINGS

The above and other aspects, features, and advantages of certain example embodiments will be more apparent from the following detailed description, taken in conjunction with the accompanying drawings, in which:

FIG. 1 is a flowchart illustrating a process of operating an artificial intelligence (AI) agent based on a communal space in an electronic device including the AI agent according to an example embodiment;

FIG. 2 is a flowchart illustrating a process of collecting user information about a user participating in a communal space event in an electronic device including an AI agent according to an example embodiment;

FIG. 3 is a flowchart illustrating a process of providing history information when a communal space event ends in an electronic device including an AI agent according to an example embodiment;

FIG. 4 is a flowchart illustrating an example of performing processing when a user leaves a communal space before a communal space event ends in an electronic device including an AI agent according to an example embodiment;

FIG. 5 is a flowchart illustrating another example of performing processing when a user leaves a communal space before a communal space event ends in an electronic device including an AI agent according to an example embodiment;

FIG. 6 is a flowchart illustrating a process of adding a domain in an electronic device including an AI agent according to an example embodiment;

FIG. 7 is a diagram illustrating an example in which an electronic device including an AI agent operates in a communal space according to an example embodiment;

FIG. 8 is a diagram illustrating a process of operating an electronic device including an AI agent in a communal space to arrange a vacation schedule according to an example embodiment;

FIG. 9 is a diagram illustrating an example of providing history information in an electronic device including an AI agent according to an example embodiment;

FIG. 10 is a diagram illustrating a configuration of an electronic device including an AI agent in a communal space according to an example embodiment;

FIG. 11 is a block diagram of an electronic device in a network environment according to an example embodiment;

FIG. 12 is a drawing illustrating a structure of an electronic device implemented in a form of wearable augmented reality (AR) glasses according to an example embodiment;

FIG. 13 is a block diagram illustrating an integrated intelligence system according to an example embodiment; and

FIG. 14 is a diagram illustrating a form in which information on a relationship between concepts and actions is stored in a database (DB) according to an example embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms. When one component is described as being “connected,” “coupled,” or “attached” to another component, it should be understood that one component may be connected or attached directly or indirectly to another component, and an intervening component(s) may be “connected,” “coupled,” or “attached” to the components. Thus, words such as “connected” include both direct and indirect connections.

The same name may be used to describe a component included in the embodiments described above and a component having a common function. Unless otherwise mentioned, the description on one embodiment may be applicable to other embodiments and thus, duplicated descriptions will be omitted for conciseness.

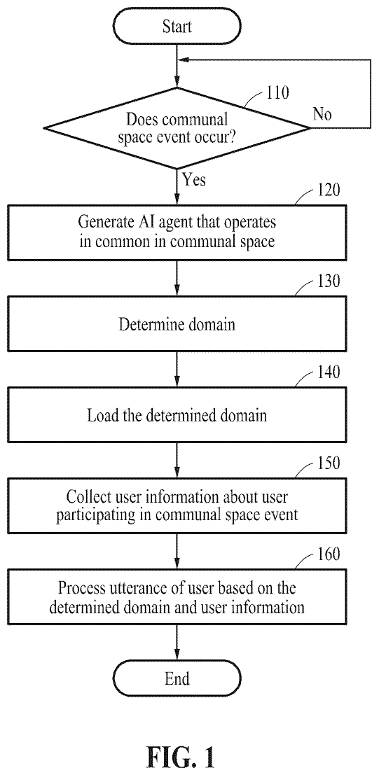

Hereinafter, a device and method for operating an artificial intelligence (AI) agent in a communal space according to an embodiment of the present disclosure are described in detail with reference to FIGS. 1 to 14.

FIG. 1 is a flowchart illustrating a process of operating an AI agent based on a communal space in an electronic device including the AI agent according to an embodiment.

Referring to FIG. 1, the electronic device including the AI agent may determine whether a communal space event occurs in operation 110.

When the communal space event is determined to occur in operation 110, the electronic device including the AI agent may generate an AI agent that operates in common in a communal space in operation 120. If “No” in 110, then it circles back as shown in FIG. 1.

In operation 130, the electronic device including the AI agent may determine a domain.

In operation 130, the electronic device including the AI agent may determine a domain corresponding to a result obtained by analyzing a name, a theme, or a description of the communal space. Alternatively, the electronic device including the AI agent may also determine a domain by receiving domain information selected by a user who generates the communal space event.

In operation 140, the electronic device including the AI agent may load the determined domain. More specifically, the electronic device including the AI agent may apply at least one model corresponding to the determined domain to at least one of an automatic speech recognition (ASR) module, a natural language understanding (NLU) module, a natural language generator (NLG) module, a text-to-speech (TTS) module, or an image processing module.

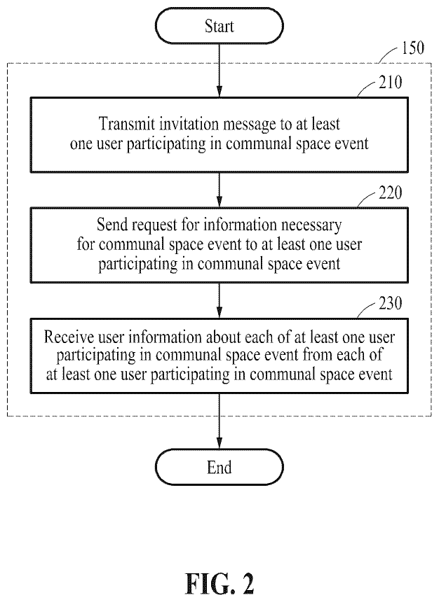

In operation 150, the electronic device including the AI agent may collect user information about a user participating in the communal space event. Operation 150 will be described in more detail below with reference to FIG. 2.

In addition, the electronic device including the AI agent may process an utterance of the user based on the determined domain and the user information in operation 160. “Based on” as used herein covers based at least on.

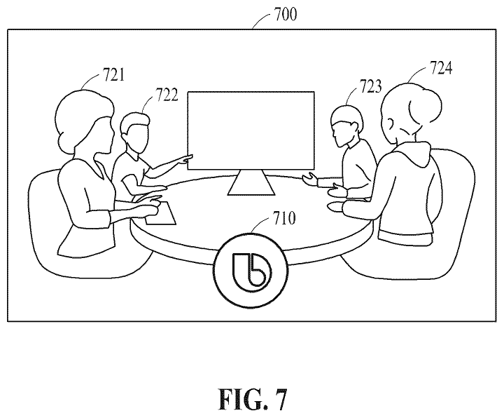

FIG. 7 is a diagram illustrating an example in which an AI agent operates in a communal space according to an embodiment.

Referring to FIG. 7, when a communal space event for a meeting occurs, an electronic device including the AI agent may generate a communal space 700 and display users 721, 722, 723, and 724 in the communal space 700. Here, the electronic device including the AI agent may additionally display a single AI agent in the form of a virtual object 710 as a representative.

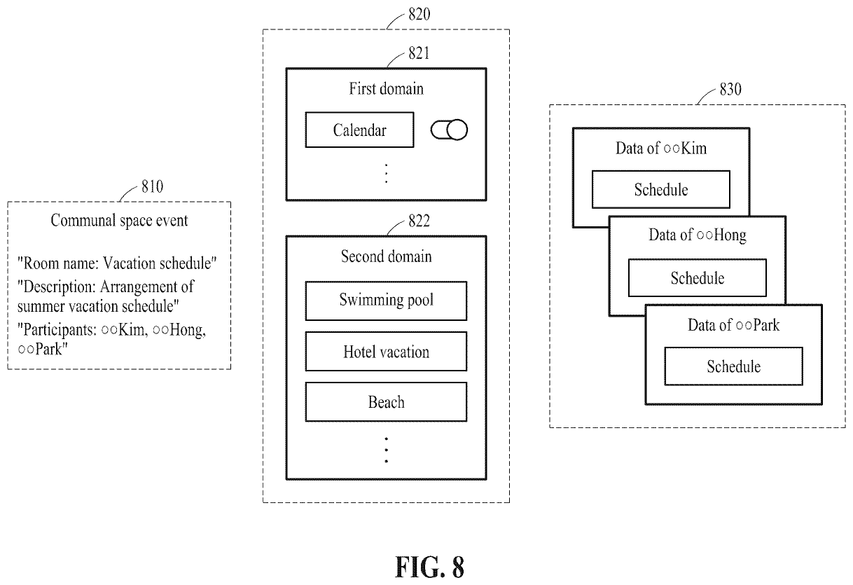

FIG. 8 is a diagram illustrating an example of a process of operating an AI agent in a communal space to arrange a vacation schedule according to an embodiment.

FIG. 8 illustrates an example in which a communal space is formed such that a company establishes a summer vacation plan.

When detecting an occurrence of a communal space event 810, in which a room name is vacation schedule, in which a description of a communal space is an arrangement of a summer vacation schedule, and in which participants are OO Kim, OO Hong, and OO Park, an electronic device including the AI agent may generate a communal space.

Here, the electronic device including the AI agent may load at least one domain 820 based on the name and the description included in the communal space event 810.

Here, the at least one domain 820 may include a first domain 821 that may include a calendar, and a second domain 822 that may include pool information, hotel vacation information, and beach information that are appropriate to a vacation location.

In addition, the electronic device including the AI agent may transmit an invitation to the communal space to each of OO Kim, OO Hong, and OO Park, corresponding to participants 830, may send a request for a schedule to each of OO Kim, OO Hong, and OO Park for the vacation schedule, and may receive information about schedules from participants.

FIG. 2 is a flowchart illustrating a process of collecting user information about a user participating in a communal space event in an electronic device including an AI agent according to an embodiment.

Referring to FIG. 2, in operation 210, the electronic device including the AI agent may transmit an invitation message to at least one user participating in a communal space event.

In operation 220, the electronic device including the AI agent may send a request for information necessary for the communal space event to the at least one user participating in the communal space event.

In operation 230, the electronic device including the AI agent may receive user information about each of the at least one user participating in the communal space event from each of the at least one user participating in the communal spaced event.

A user may classify requested data into data that can be provided and data that cannot be provided, and may provide the data that can be provided to the electronic device including the AI agent.

User information, which is data provided to the electronic device including the AI agent, may be classified into public data of the user that is data allowed to be disclosed to other users in the communal space, private data of the user that is data that is not allowed to be disclosed to the other users in the communal space, shared data that is data related to the other users in the communal space, and personal data that is data unrelated to the other users in the communal space.

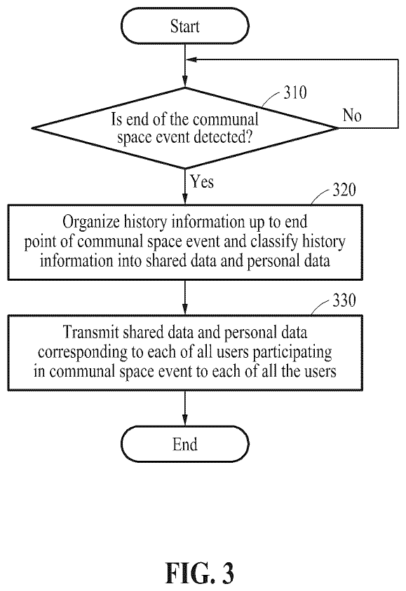

FIG. 3 is a flowchart illustrating a process of providing history information when a communal space event ends in an electronic device including an AI agent according to an embodiment.

Referring to FIG. 3, when an end of the communal space event is detected in operation 310, the electronic device including the AI agent may organize history information up to an end point of the communal space event and may classify the history information into shared data and personal data in operation 320.

In addition, in operation 330, the electronic device including the AI agent may transmit the shared data and personal data corresponding to each of all users participating in the communal space event to each of all the users.

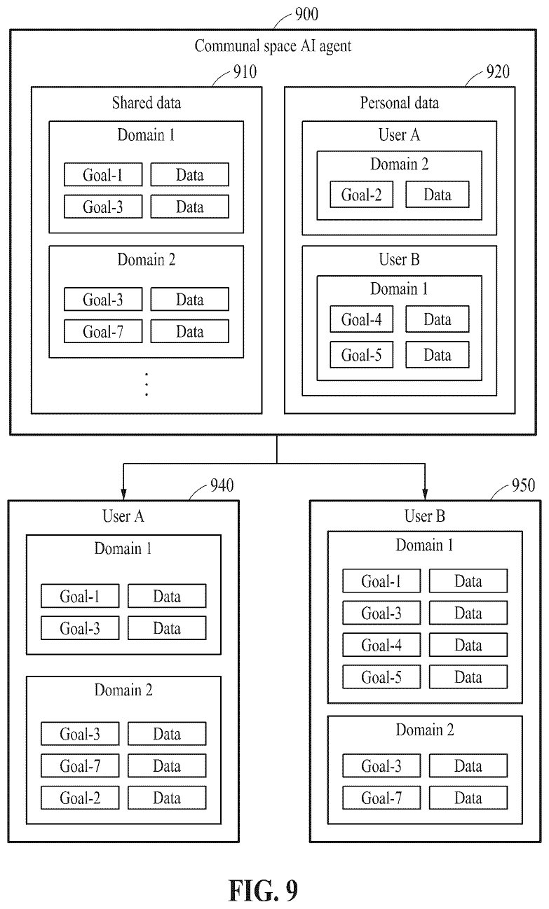

FIG. 9 is a diagram illustrating an example of providing history information in an electronic device including an AI agent according to an embodiment.

Referring to FIG. 9, a communal space AI agent 900 may store and manage history information generated in a communal space by classifying the history information into shared data 910 and personal data 920.

When an end of a communal space event is detected, the communal space AI agent 900 may organize the history information up to an end point of the communal space event, may classify the history information into the shared data 910 and the personal data 920 and may transmit the shared data 910 and personal data corresponding to each of users 940 and 950 to the users 940 and 950.

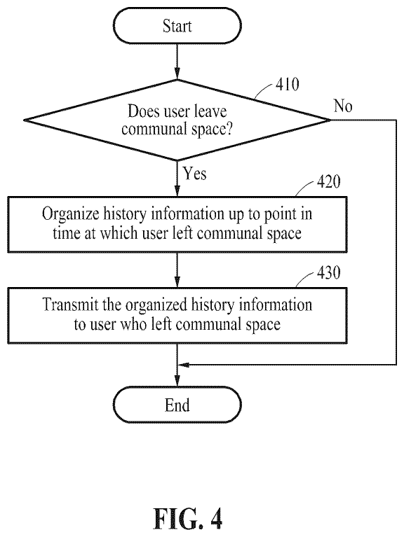

FIG. 4 is a flowchart illustrating an example of performing processing when a user leaves a communal space before a communal space event ends in an electronic device including an AI agent according to an embodiment.

Referring to FIG. 4, when it is detected that the user has left the communal space in operation 410, the electronic device including the AI agent may organize history information up to a point in time at which the user left the communal space in operation 420.

In operation 430, the electronic device including the AI agent may transmit the organized history information to the user who left the communal space. In operation 430, the history information may be information classified into shared data and personal data as described above with reference to FIG. 3.

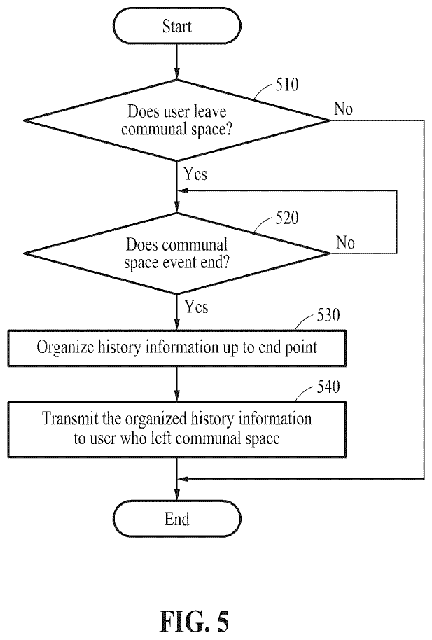

FIG. 5 is a flowchart illustrating another example of performing processing when a user leaves a communal space before a communal space event ends in an electronic device including an AI agent according to an embodiment.

Referring to FIG. 5, when it is detected that the user has left the communal space in operation 510, the electronic device including the AI agent may determine whether the communal space event ends in operation 520.

When it is determined that the communal space event ends in operation 520, the electronic device including the AI agent may organize history information up to an end point of the communal space event in operation 530.

In addition, the electronic device including the AI agent may transmit the organized history information to the user who left the communal space in operation 540. In operation 540, the history information may be information classified into shared data and personal data as described above with reference to FIG. 3.

In FIGS. 4 and 5, whether to provide the user who left the communal space with the history information associated with the point in time at which the user left the communal space or provide the history information associated with the end point of the communal space event may be selectively applied depending on a request of the user who left the communal space or settings of a user who opened the communal space event.

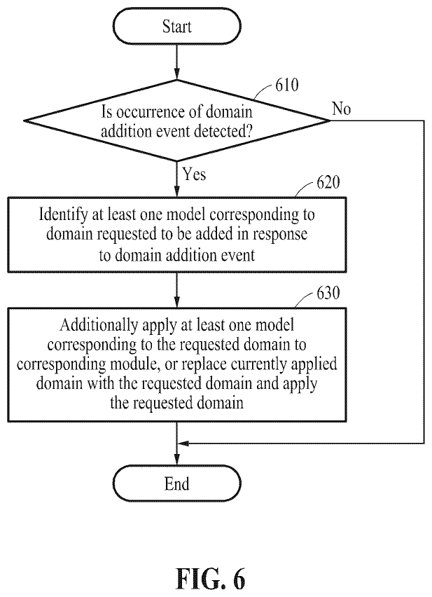

FIG. 6 is a flowchart illustrating a process of adding a domain in an electronic device including an AI agent according to an embodiment.

Referring to FIG. 6, the electronic device including the AI agent may determine whether a domain addition event occurs in operation 610.

In operation 610, when processing of an input of a user using a currently applied domain is impossible during analyzing and processing of the input of the user, the electronic device including the AI agent may search for a domain corresponding to the input of the user and may trigger an occurrence of a domain addition event for requesting an addition of the found domain or a replacement with the found domain.

In operation 610, when a request for an addition of a new domain or a replacement with the new domain is received from the user, the electronic device including the AI agent may trigger an occurrence of a domain addition event for requesting the addition of the new domain or the replacement with the new domain.

When the domain addition event is determined to occur in operation 610, the electronic device including the AI agent may identify at least one model corresponding to a domain requested to be added in response to the domain addition event in operation 620.

In addition, the electronic device including the AI agent may additionally apply the at least one model corresponding to the requested domain to a corresponding module, or may replace the currently applied domain with the requested domain and apply the requested domain in operation 630.

Specifically, the electronic device including the AI agent may additionally apply at least one model corresponding to the requested domain to at least one of an ASR module, an NLU module, an NLG module, a TTS module, or an image processing module, or may replace the currently applied domain with the requested domain and apply the requested domain.

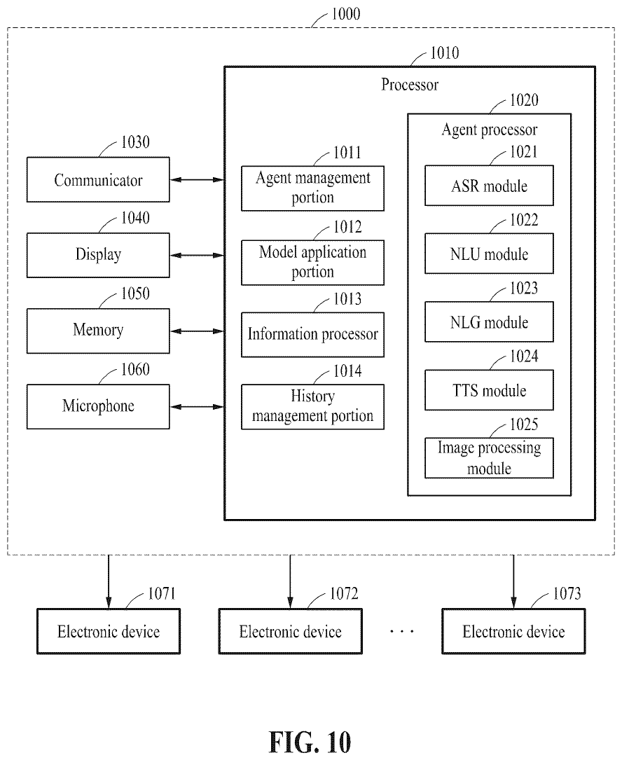

FIG. 10 is a diagram illustrating a configuration of an electronic device for operating an AI agent in a communal space according to an embodiment.

Referring to FIG. 10, an electronic device 1000 including an AI agent may include a processor 1010, a communicator 1030, a display 1040, a memory 1050, and a microphone 1060.

The communicator 1030 may be a communication interface device including a receiver and a transmitter and may communicate with an intelligent server that processes an uttered voice and responds to a processing result. In addition, the communicator 1030 may perform communication with other electronic devices 1071 to 1073 participating in the communal space.

The display 1040 may display state information (or indicator) generated during an operation of the electronic device 1000 including the AI agent, limited numbers and characters, moving pictures, still pictures, and the like. In addition, the display 1040 may display, as a virtual object, an AI agent that provides a voice assistant under a control of the processor 1010.

The memory 1050 may store an operating system (OS) to control the overall operation of the electronic device 1000 including the AI agent, application program, and data for storing. In addition, the memory 1050 may store user information collected through an information processor 1013 and store history information generated during a communal space event.

The microphone 1060 may process an external sound signal as electrical voice data.

The processor 1010 may include an agent management portion 1011, a model application portion 1012, the information processor 1013, a history management portion 1014, and an agent processor 1020.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The agent management portion 1011 may, when a communal space event occurs, generate an AI agent that operates in common in a communal space and determine a domain to be applied to the AI agent.

Here, the agent management portion 1011 may determine a domain corresponding to a result obtained by analyzing a name, a theme, or a description of the communal space. Alternatively, the agent management portion 1011 may receive domain information selected by a user generating the communal space event and may determine a domain.

When an occurrence of a domain addition event is detected, the agent management portion 1011 may transmit a domain, requested to be added, to the model application portion 1012. Here, when processing of an input of a user using a currently applied domain is impossible during analyzing and processing of the input of the user, the agent management portion 1011 may search for a domain corresponding to the input of the user and may trigger an occurrence of a domain addition event for requesting an addition of the found domain or a replacement with the found domain. In addition, when a request for an addition of a new domain or a replacement with the new domain is received from the user, the agent management portion 1011 may trigger an occurrence of a domain addition event for requesting the addition of the new domain or the replacement with the new domain.

The model application portion 1012 may load the determined domain.

For example, the model application portion 1012 may apply at least one model corresponding to the requested domain to at least one of an ASR module, an NLU module, an NLG module, a TTS module, or an image processing module.

The information processor 1013 may collect user information about a user participating in the communal space event. More specifically, the information processor 1013 may transmit an invitation message to at least one user participating in the communal space event, may send a request for information necessary for the communal space event to the at least one user participating in the communal space event, and may receive user information about each of the at least one user participating in the communal space event from each of the at least one user. Here, the received user information may be information provided by a user and may include at least one of public data of the user that is data allowed to be disclosed to other users in the communal space, private data of the user that is data that is not allowed to be disclosed to the other users in the communal space, shared data that is data related to the other users in the communal space, and personal data that is data unrelated to the other users in the communal space.

When the user participating in the communal space event leaves the communal space before the communal space event ends, the information processor 1013 may provide the user who left the communal space with history information organized up to a point in time at which the user left the communal space.

When the user participating in the communal space event leaves the communal space before the communal space event ends, the information processor 1013 may provide the user who left the communal space with history information organized up to an end point of the communal space event after the communal space event ends.

Whether to provide the user who left the communal space with the history information associated with the point in time at which the user left the communal space or provide the history information associated with the end point of the communal space event may be selectively applied depending on a request of the user who left the communal space or settings of a user who opened the communal space event. Here, the history information may be classified into shared data and personal data corresponding to each user, and the personal data may include only data of a corresponding user.

When the communal space event ends, the information processor 1013 may provide history information organized up to the end point of the communal space event after the communal space event ends to each of all users participating in the communal space event.

Specifically, when the communal space event ends, the information processor 1013 may classify the history information organized up to the end point of the communal space event after the communal space event ends into shared data and personal data and may provide the shared data and personal data corresponding to each user to all the electronic devices 1071, 1072, and 1073 participating in the communal space event.

When the history information is provided to a user, when AI agents of the same type are used by the electronic device 1000 including the AI agent and the user receiving the provided history information, the information processor 1013 may transmit the history information without a change, because the same data format is used.

When the history information is provided to a user, when AI agents of different types are used by the electronic device 1000 including the AI agent and the user receiving the provided history information, the information processor 1013 may convert the history information to a standardized data format or a data format used in an AI agent used by the user receiving the provided history information and may transmit the history information.

The history management portion 1014 may store and manage history information including processing result data and input data processed in the AI agent in the memory 1050. The agent processor 1020 may process an utterance of the user based on the determined domain and the user information.

The agent processor 1020 may include an ASR module 1021, an NLU module 1022, an NLG module 1023, a TTS module 1024, or an image processing module 1025.

The ASR module 1021 may convert a received voice input into text data.

The NLU module 1022 may discern an intent of a user using the text data of the voice input.

The NLG module 1023 may change designated information into a text form.

The TTS module 1024 may change information in a text form into information in a speech form.

The image processing module 1025 may analyze the received images.

The agent processor 1020 may be configured to be included in the electronic device 1000 including the AI agent or may be implemented as an intelligent device disposed outside the electronic device 1000, and may respond to a processing result by communication through the communicator 1030.

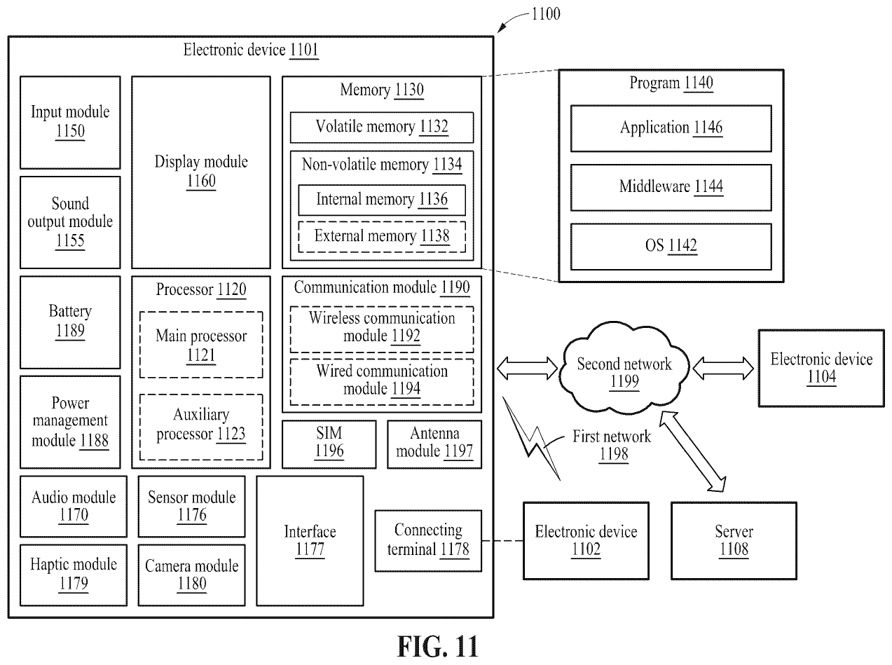

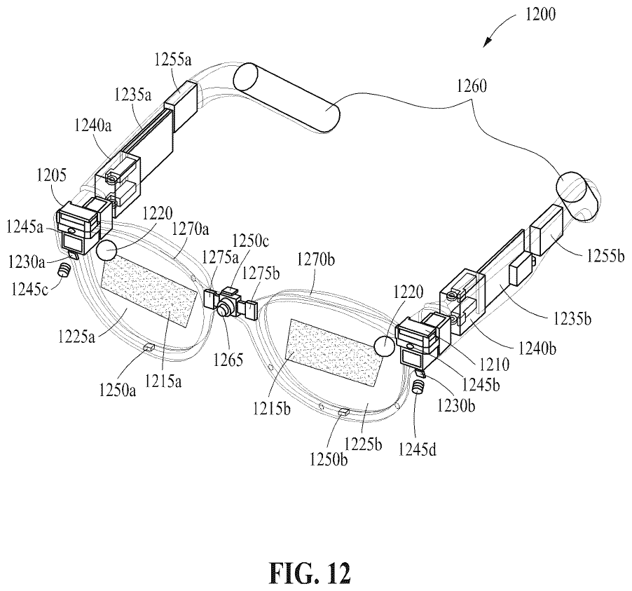

In addition, the electronic device 1000 including the AI agent of FIG. 10 may be configured in the form of an electronic device 1101 in a network environment as shown in FIG. 11 below or may also be configured in the form of wearable augmented reality (AR) glasses 1200 as shown in FIG. 12.

FIG. 11 is a block diagram illustrating an electronic device 1101 in a network environment 1100 according to an embodiment.

Referring to FIG. 11, the electronic device 1101 in the network environment 1100 may communicate with an electronic device 1102 via a first network 1198 (e.g., a short-range wireless communication network), or communicate with at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, a memory 1130, an input module 1150, a sound output module 1155, a display module 1160, an audio module 1170, and a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be integrated as a single component (e.g., the display module 1160).

The processor 1120 may execute, for example, software (e.g., a program 1140) to control at least one other component (e.g., a hardware or software component) of the electronic device 1101 connected, directly or indirectly, to the processor 1120 and may perform various data processing or computation. According to an embodiment, as at least part of data processing or computation, the processor 1120 may store a command or data received from another component (e.g., the sensor module 1176 or the communication module 1190) in a volatile memory 1132, process the command or the data stored in the volatile memory 1132, and store resulting data in a non-volatile memory 1134 (which may include internal memory 1136 and/or external memory 1138 for example). According to an embodiment, the processor 1120 may include a main processor 1121 (e.g., a central processing unit (CPU) or an application processor (AP)) or an auxiliary processor 1123 (e.g., a graphics processing unit (GPU), a neural processing unit (NPU), an image signal processor (ISP), a sensor hub processor, or a communication processor (CP)) that is operable independently of, or in conjunction with the main processor 1121. For example, when the electronic device 1101 includes the main processor 1121 and the auxiliary processor 1123, the auxiliary processor 1123 may be adapted to consume less power than the main processor 1121 or to be specific to a specified function. The auxiliary processor 1123 may be implemented separately from the main processor 1121 or as a part of the main processor 1121.

The auxiliary processor 1123 may control at least some of functions or states related to at least one (e.g., the display module 1160, the sensor module 1176, or the communication module 1190) of the components of the electronic device 1101, instead of the main processor 1121 while the main processor 1121 is in an inactive (e.g., sleep) state or along with the main processor 1121 while the main processor 1121 is in an active state (e.g., executing an application). According to an embodiment, the auxiliary processor 1123 (e.g., an ISP or a CP) may be implemented as a portion of another component (e.g., the camera module 1180 or the communication module 1190) that is functionally related to the auxiliary processor 1123. According to an embodiment, the auxiliary processor 1123 (e.g., an NPU) may include a hardware structure specified for AI model processing. An AI model may be generated through machine learning. Such learning may be performed, for example, by the electronic device 1101 in which an AI model is executed, or via a separate server (e.g., the server 1108). Learning algorithms may include, but are not limited to, e.g., supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

Meanwhile, the processor 1120 may perform operation 1010 of FIG. 10.

The memory 1130 may store various pieces of data used by at least one component (e.g., the processor 1120 or the sensor module 1176) of the electronic device 1101. The various pieces of data may include, for example, software (e.g., the program 1140) and input data or output data for a command related thereto. The memory 1130 may include the volatile memory 1132 or the non-volatile memory 1134.

The program 1140 may be stored as software in the memory 1130, and may include, for example, an OS 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen). The sound output module 1155 may output a sound signal to the outside of the electronic device 1101. The sound output module 1155 may include, for example, a speaker or a receiver. The speaker may be used for general purposes, such as playing multimedia or playing a record. The receiver may be used to receive an incoming call. According to an embodiment, the receiver may be implemented separately from the speaker or as a portion of the speaker.

The display module 1160 may visually provide information to the outside (e.g., a user) of the electronic device 1101. The display module 1160 may include, for example, a display, a hologram device, or a projector and control circuitry to control a corresponding one of the display, the hologram device, and the projector. According to an embodiment, the display module 1160 may include a touch sensor adapted to sense a touch, or a pressure sensor adapted to measure an intensity of a force incurred by the touch.

The audio module 1170 may convert a sound into an electrical signal or vice versa. According to an embodiment, the audio module 1170 may obtain the sound via the input module 1150 or output the sound via the sound output module 1155 or an external electronic device (e.g., an electronic device 1102 such as a speaker or a headphone) directly or wirelessly coupled with the electronic device 1101.

The sensor module 1176 may detect an operational state (e.g., power or temperature) of the electronic device 1101 or an environmental state (e.g., a state of a user) external to the electronic device 1101, and generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, a Hall sensor, or an illuminance sensor.

In addition, the sensor module 1176 may further include a camera module that may a still image and moving images. The camera module may include one or more lenses, image sensors, ISPs, or flashes.

The interface 1177 may support one or more specified protocols to be used for the electronic device 1101 to be coupled with the external electronic device (e.g., the electronic device 1102) directly (e.g., by wire) or wirelessly. According to an embodiment, the interface 1177 may include, for example, a high-definition multimedia interface (HDMI), a universal serial bus (USB) interface, a secure digital (SD) card interface, or an audio interface.

For example, the electronic device 1101 may transmit an image signal to an external electronic device through the connecting terminal 1178. The electronic device 1101 may transmit an image signal that allows the external electronic device to output an image to the display module of the external electronic device.

The connecting terminal 1178 may be used to output an image signal or a voice signal. For example, the connecting terminal 1178 may simultaneously output an image signal and a voice signal. For example, the electronic device 1101 may output an image signal and a voice signal through an interface, such as an HDMI, a display port (DP), or a Thunderbolt, in the connecting terminal 1178 that simultaneously outputs the image and the voice signal.

The connecting terminal 1178 may include a connector via which the electronic device 1101 may be physically connected to an external electronic device (e.g., the electronic device 1102). According to an embodiment, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or an electrical stimulus which may be recognized by a user via his or her tactile sensation or kinesthetic sensation. According to an embodiment, the haptic module 1179 may include, for example, a motor, a piezoelectric element, or an electric stimulator.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190, comprising communication circuitry, may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more CPs that are operable independently of the processor 1120 (e.g., an AP) and that support a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module, or a power line communication (PLC) module). A corresponding one of these communication modules may communicate with the external electronic device 1104 via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multiple components (e.g., multiple chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the SIM 1196.

The wireless communication module 1192, comprising communication circuitry, may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., a mmWave band) to achieve, e.g., a high data transmission rate. The wireless communication module 1192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., an external electronic device) of the electronic device 1101. According to an embodiment, the antenna module 1197 may include an antenna including a radiating element including a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in a communication network, such as the first network 1198 or the second network 1199, may be selected by, for example, the communication module 1190 from the plurality of antennas. The signal or power may be transmitted or received between the communication module 1190 and the external electronic device via the at least one selected antenna. According to an embodiment, another component (e.g., a radio frequency integrated circuit (RFIC)) other than the radiating element may be additionally formed as a part of the antenna module 1197.

According to various embodiments, the antenna module 1197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the external electronic devices 1102 or 1104 may be a device of the same type as or a different type from the electronic device 1101. According to an embodiment, all or some of operations to be executed at the electronic device 1101 may be executed at one or more of external electronic devices (e.g., the external devices 1102 and 1104, and the server 1108). For example, if the electronic device 1101 needs to perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 1101. The electronic device 1101 may provide the outcome, with or without further processing of the outcome, as at least part of a reply to the request. To this end, cloud computing, distributed computing, mobile edge computing (MEC), or client-server computing technology may be used, for example. The electronic device 1101 may provide ultra low-latency services using, e.g., distributed computing or MEC. In an embodiment, the external electronic device 1104 may include an Internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

FIG. 12 is a diagram illustrating a structure of an electronic device implemented in the form of wearable AR glasses according to an embodiment.

Referring to FIG. 12, an electronic device 1200 may be worn on a face of a user to provide an image associated with an AR service and/or a virtual reality (VR) service to the user.

In an embodiment, the electronic device 1200 may include a first display 1205, a second display 1210, a first screen display portion 1215a, a second screen display portion 1215b, an input optical member 1220, a first transparent member 1225a, a second transparent member 1225b, lighting units 1230a and 1230b, a first PCB 1235a, a second PCB 1235b, a first hinge 1240a, a second hinge 1240b, first cameras 1245a, 1245b, 1245c, and 1245d, a plurality of microphones (e.g., a first microphone 1250a, a second microphone 1250b, and a third microphone 1250c), a plurality of speakers (e.g., a first speaker 1255a and a second speaker 1255b), a battery 1260, second cameras 1275a and 1275b, a third camera 1265, and visors 1270a and 1270b.

In an embodiment, a display (e.g., the first display 1205 and the second display 1210) may include, for example, a liquid crystal display (LCD), a digital micromirror device (DMD), or a liquid crystal on silicon (LCoS), an organic light-emitting diode (OLED), or a micro light-emitting diode (micro LED). Although not shown in the drawings, when the display is one of an LCD, a DMD, and an LCOS, the electronic device 1200 may include a light source that emits light to a screen output area of the display. In an embodiment, when the display is capable of generating light by itself, when the display is either an OLED or a micro LED, for example, the electronic device 1200 may provide a virtual image with a relatively high quality to the user even though a separate light source is not included. In an embodiment, when the display is implemented as an OLED or a micro LED, a light source may be unnecessary, which may lead to lightening of the electronic device 1200. Hereinafter, a display capable of generating light by itself may be also referred to as a “self-luminous display,” and a description will be made on the assumption of the self-luminous display.

A display (e.g., the first display 1205 and the second display 1210) according to various embodiments may include at least one micro LED. For example, the micro LED may express red (R), green (G), and blue (B) by emitting light by itself, and a single chip may implement a single pixel (e.g., one of R, G, and B pixels) because the micro LED is relatively small in size (e.g., 100 micrometers (μm) or less). Accordingly, it may be possible to provide a high resolution without a backlight unit (BLU) when the display is implemented as a micro LED.

However, embodiments are not limited thereto, and a single chip may be implemented by a plurality of pixels including R, G, and B pixels.

In an embodiment, the display (e.g., the first display 1205 and the second display 1210) may include a display area including pixels for displaying a virtual image, and light-receiving pixels (e.g., photo sensor pixels) that are arranged among the pixels and configured to receive light reflected from eyes, convert the received light into electrical energy, and output the electrical energy.

In an embodiment, the electronic device 1200 may detect a gaze direction (e.g., a movement of a pupil) of the user through the light-receiving pixels. For example, the electronic device 1200 may detect and track a gaze direction of a right eye of the user and a gaze direction of a left eye of the user through one or more light-receiving pixels of the first display 1205 and one or more light-receiving pixels of the second display 1210. The electronic device 1200 may determine a central position of a virtual image according to the gaze directions of the right eye and the left eye of the user (e.g., directions in which pupils of the right eye and the left eye of the user gaze) detected through the one or more light-receiving pixels.

In an embodiment, light emitted from the display (e.g., the first display 1205 and the second display 1210) may reach the first screen display portion 1215a formed on the first transparent member 1225a that faces the right eye of the user, and the second screen display portion 1215b formed on the second transparent member 1225b that faces the left eye of the user, by passing through a lens (not shown) and a waveguide. For example, the light emitted from the display (e.g., the first display 1205 and the second display 1210) may pass through the waveguide and may be reflected by a grating area formed on the input optical member 1220 and the first screen display portion 1215a and the second screen display portion 1215b, to be transmitted to the eyes of the user. The first transparent member 1225a and/or the second transparent member 1225b may be formed by a glass plate, a plastic plate, or a polymer, and may be transparently or translucently formed.

In an embodiment, a lens (not shown) may be disposed on a front surface of the display (e.g., the first display 1205 and the second display 1210). The lens (not shown) may include a concave lens and/or a convex lens. For example, the lens (not shown) may include a projection lens or a collimation lens.

In an embodiment, the first screen display portion 1215a and the second screen display portion 1215b, or a transparent member (e.g., the first transparent member 1225a and the second transparent member 1225b) may include a lens including a waveguide, and a reflective lens.

In an embodiment, the waveguide may be formed of glass, plastic, or a polymer and may have a nanopattern, for example, a grating structure having a polygonal or curved shape, formed on one inner surface or one outer surface of the waveguide. According to an embodiment, light incident to one end of the waveguide may be propagated inside the display waveguide through the nanopattern to be provided to a user. In an embodiment, a waveguide including a freeform prism may provide incident light to a user through a reflection mirror. The waveguide may include at least one of at least one diffractive element (e.g., a diffractive optical element (DOE) and a holographic optical element (HOE)), or a reflective element (e.g., a reflection mirror). In an embodiment, the waveguide may guide light emitted from the first display 1205 and the second display 1210 to the eyes of the user, using the at least one diffractive element or the reflective element included in the waveguide.

According to various embodiments, the diffractive element may include the input optical member 1220 and/or an output optical member (not shown). For example, the input optical member 1220 may be an input grating area, and the output optical member (not shown) may be an output grating area. The input grating area may function as an input terminal to diffract (or reflect) light output from the display (e.g., the first display 1205 and the second display 1210 (e.g., a micro LED)) to transmit the light to transparent members (e.g., the first transparent member 1225a and the second transparent member 1225b) of the first screen display portion 1215a and the second screen display portion 1215b. The output grating area may function as an exit to diffract (or reflect), to the eyes of the user, the light transmitted to the transparent members (e.g., the first transparent member 1225a and the second transparent member 1225b) of the waveguide.

According to various embodiments, the reflective element may include a total reflection optical element or a total reflection waveguide for total internal reflection (TIR). For example, TIR, which is a scheme of inducing light, may be forming an angle of incidence to allow light (e.g., a virtual image) input through an input grating area to be completely (100%) reflected from one surface (e.g., a specific surface) of the waveguide such that the light may be completely (100%) transmitted to an output grating area.

In an embodiment, the light emitted from the first display 1205 and the second display 1210 may be guided by the waveguide through the input optical member 1220. Light traveling in the waveguide may be guided toward the eyes of the user through the output optical member. The first screen display portion 1215a and the second screen display portion 1215b may be determined based on light emitted toward the eyes.

In an embodiment, the first cameras 1245a, 1245b, 1245c, and 1245d may each include a camera used for three degrees of freedom (3DoF) and six degrees of freedom (6DoF) head tracking, hand detection and tracking, and gesture and/or space recognition. For example, the first cameras 1245a, 1245b, 1245c, and 1245d may each include a global shutter (GS) camera to detect a movement of a head and a hand and track the movement.

For example, a stereo camera may be applied and cameras with the same standard and performance may be applied, as the first cameras 1245a, 1245b, 1245c, and 1245d for head tracking and space recognition. A GS camera having excellent performance (e.g., image dragging) may be used as the first cameras 1245a, 1245b, 1245c, and 1245d to detect a minute movement such as a quick movement of a hand or a finger and to track a movement.

According to various embodiments, a rolling shutter (RS) camera may be used as the first cameras 1245a, 1245b, 1245c, and 1245d. The first cameras 1245a, 1245b, 1245c, and 1245d may perform a function of a simultaneous localization and mapping (SLAM) through depth imaging and space recognition for 6DoF. The first cameras 1245a, 1245b, 1245c, and 1245d may perform a user gesture recognition function.

In an embodiment, the second cameras 1275a and 1275b may be used for detecting and tracking pupils. The second cameras 1275a and 1275b may also be referred to as cameras for eye tracking (ET). The second cameras 1275a and 1275b may track a gaze direction of a user. In consideration of the gaze direction of the user, the electronic device 1200 may position a center of a virtual image projected on the first screen display portion 1215a and the second screen display portion 1215b according to the gaze direction of the user.

A GS camera may be used as the second cameras 1275a and 1275b to detect a pupil and track a quick movement of the pupil. The second cameras 1275a and 1275b may be installed respectively for a right eye and a left eye, and cameras having the same performance and standard may be used as the second cameras 1275a and 1275b for the right eye and the left eye.

In an embodiment, the third camera 1265 may also be referred to as a “high resolution (HR)” or a “photo video (PV)” and may include a high-resolution camera. The third camera 1265 may include a color camera having functions for obtaining a high-quality image, such as an automatic focus (AF) function and an optical image stabilizer (OIS). Embodiments are not limited thereto, and the third camera 1265 may include a GS camera or an RS camera.

In an embodiment, at least one sensor (e.g., a gyro sensor, an acceleration sensor, a geomagnetic sensor, a touch sensor, an illuminance sensor, and/or a gesture sensor), the first cameras 1245a, 1245b, 1245c, and 1245d may perform at least one of head tracking for 6DoF, pose estimation and prediction, gesture and/or space recognition, or a function of a SLAM through depth imaging.

In an embodiment, the first cameras 1245a, 1245b, 1245c, and 1245d may be classified and used as a camera for head tracking and a camera for hand tracking.

In an embodiment, the lighting units 1230a and 1230b may be used differently according to positions in which the light units 1230a and 1230b are attached. For example, the lighting units 1230a and 1230b may be attached together with the first cameras 1245a, 1245b, 1245c, and 1245d mounted around a hinge (e.g., the first hinge 1240a and the second hinge 1240b) that connects a frame and a temple or around a bridge that connects frames. If capturing is performed using a GS camera, the lighting units 1230a and 1230b may be used to supplement a surrounding brightness. For example, the lighting units 1230a and 1230b may be used in a dark environment or when it is not easy to detect a subject to be captured due to reflected light and mixing of various light sources.

In an embodiment, a PCB (e.g., the first PCB 1235a and the second PCB 1235b) may include a processor (not shown), a memory (not shown), and a communication module (not shown) that control components of the electronic device 1200.

Each embodiment herein may be used in combination with any other embodiment(s) described herein.

The communication module (not shown) may support establishing a direct (e.g., wired) communication channel or wireless communication channel between the electronic device 1200 and an external electronic device and performing communication through the established communication channel. The PCB may transmit electrical signals to the components constituting the electronic device 1200.

The communication module (not shown) may include one or more communication processors that are operable independently of the processor and that support a direct (e.g., wired) communication or a wireless communication. According to an embodiment, the communication module (not shown) may include a wireless communication module (e.g., a cellular communication module, a short-range wireless communication module, or a global navigation satellite system (GNSS) communication module) or a wired communication module (e.g., a local area network (LAN) communication module, or a power line communication (PLC) module). A corresponding one (not shown) of these communication modules may communicate with the external electronic device via a short-range communication network (e.g., Bluetooth™, wireless-fidelity (Wi-Fi) direct, or infrared data association (IrDA)) or a long-range communication network (e.g., a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other.

The wireless communication module may support a 5G network after a 4G network, and next-generation communication technology, e.g., NR access technology. The NR access technology may support enhanced mobile broadband (eMBB), massive machine type communications (mMTC), or ultra-reliable and low-latency communications (URLLC). The wireless communication module may support a high-frequency band (e.g., a mmWave band) to achieve, e.g., a high data transmission rate. The wireless communication module may support various technologies for securing performance on a high-frequency band, such as, e.g., beamforming, massive MIMO, FD-MIMO, an array antenna, analog beam-forming, or a large scale antenna.

The electronic device 1200 may further include an antenna module (not shown). The antenna module may transmit or receive a signal or power to or from the outside (e.g., an external electronic device) of the electronic device 1200. According to an embodiment, the antenna module may include an antenna including a radiating element including a conductive material or a conductive pattern formed in or on a substrate (e.g., the first PCB 1235a and the second PCB 1235b). According to an embodiment, the antenna module may include a plurality of antennas (e.g., array antennas).

In an embodiment, a plurality of microphones (e.g., the first microphone 1250a, the second microphone 1250b, and the third microphone 1250c) may process an external sound signal as electrical voice data. The electrical voice data may be variously utilized according to a function (or an application being executed) being performed by the electronic device 1200.

In an embodiment, the plurality of speakers (e.g., the first speaker 1255a and the second speaker 1255b) may output audio data received from the communication module or stored in the memory.

In an embodiment, one or more batteries 1260 may be included and may supply power to components constituting the electronic device 1200.

In an embodiment, the visors 1270a and 1270b may adjust a transmission amount of external light incident on the eyes of the user according to a transmittance. The visors 1270a and 1270b may be disposed in front of or behind the first screen display portion 1215a and the second screen display portion 1215b. The front side of the first screen display portion 1215a, the second screen display portion 1215b may correspond to a direction opposite to the user wearing the electronic device 1200, and the rear side may correspond to a direction of the user wearing the electronic device 1200. The visors 1270a and 1270b may protect the first screen display portion 1215a and the second screen display portion 1215b and adjust an amount of external light transmitted.

For example, the visors 1270a and 1270b may include an electrochromic element that adjusts a transmittance in response to a change in colors according to applied power. Electrochromism is a phenomenon in which colors change due to an oxidation-reduction reaction caused by applied power. The visors 1270a and 1270b may adjust a transmittance of external light, using the change in colors in the electrochromic element.

For example, the visors 1270a and 1270b may include a control module, comprising circuitry, and the electrochromic element. The control module may control the electrochromic element to adjust a transmittance of the electrochromic element.

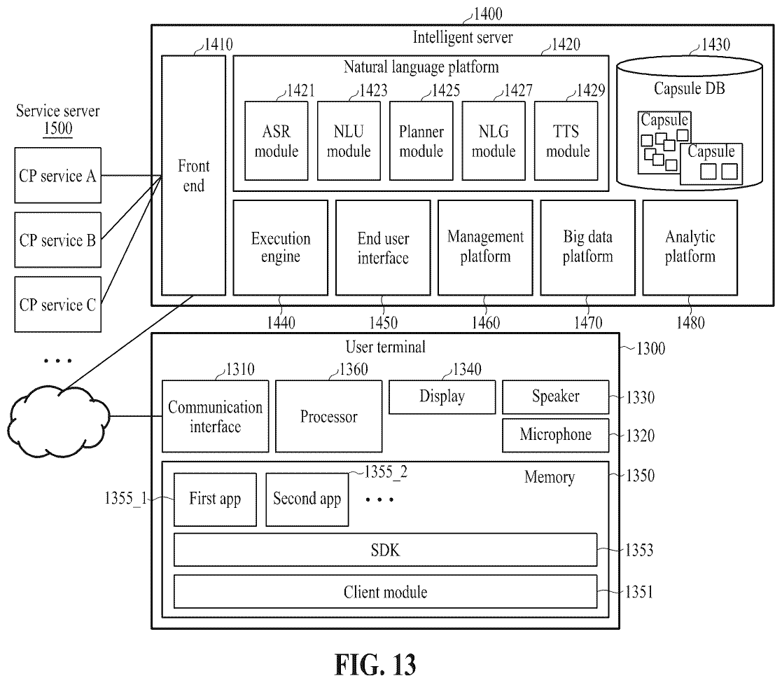

In addition, the electronic device 1000 including the AI agent of FIG. 10 may be implemented as an integrated intelligent system of FIG. 13, or the agent processor 1020 of the electronic device 1000 including the AI agent may be implemented as the integrated intelligent system when the agent processor 1020 is implemented as an external configuration.

FIG. 13 is a block diagram illustrating an integrated intelligence system according to an embodiment.

Referring to FIG. 13, the integrated intelligence system according to an embodiment may include a user terminal 1300, an intelligent server 1400, and a service server 1500.

The user terminal 1300 according to an embodiment may be a terminal device (or an electronic device) connectable to the Internet, and may be, for example, a mobile phone, a smartphone, a personal digital assistant (PDA), a notebook computer, a television (TV), a white home appliance, a wearable device, a head-mounted display (HMD), or a smart speaker.

According to the embodiments described above, the user terminal 1300 may include a communication interface 1310, a microphone 1320, a speaker 1330, a display 1340, a memory 1350, or a processor 1360. The components listed above may be operatively or electrically connected to each other.

The communication interface 1310 according to an embodiment may be connected to an external device and configured to transmit and receive data to and from the external device. The microphone 1320 according to an embodiment may receive a sound (e.g., a user utterance) and convert the sound into an electrical signal. The speaker 1330 according to an embodiment may output the electrical signal as a sound (e.g., a speech). The display 1340 according to an embodiment may be configured to display an image or video. The display 1340 according to an embodiment may also display a graphical user interface (GUI) of an app (or an application program) being executed.

The memory 1350 according to an embodiment may store a client module 1351, a software development kit (SDK) 1353, and a plurality of apps 1355. The client module 1351 and the SDK 1353 may configure a framework (or a solution program) for performing general-purpose functions. In addition, the client module 1351 or the SDK 1353 may configure a framework for processing a voice input.

The plurality of apps 1355 stored in the memory 1350 according to an embodiment may be programs for performing designated functions. According to an embodiment, the plurality of apps 1355 (e.g., see 1355_1 and 1355_2) may include a first app 1355_1, a second app 1355_2, and the like. According to an embodiment, each of the plurality of apps 1355 may include a plurality of actions for performing a designated function. For example, the apps may include an alarm app, a messaging app, and/or a scheduling app. According to an embodiment, the plurality of apps 1355 may be executed by the processor 1360 to sequentially execute at least a portion of the plurality of actions.

The processor 1360 according to an embodiment may control the overall operation of the user terminal 1300. For example, the processor 1360 may be electrically connected, directly or indirectly, to the communication interface 1310, the microphone 1320, the speaker 1330, and the display 1340 to perform a designated operation.

The processor 1360 according to an embodiment may also perform the designated function by executing the program stored in the memory 1350. For example, the processor 1360 may execute at least one of the client module 1351 or the SDK 1353 to perform the following operation for processing a voice input. The processor 1360 may control the actions of the plurality of apps 1355 through, for example, the SDK 1353. The following operation described as an operation of the client module 1351 or the SDK 1353 may be an operation by an execution of the processor 1360. Each “module” herein may comprise circuitry, such as processing circuitry.

The client module 1351 according to an embodiment may receive a voice input. For example, the client module 1351 may receive a voice signal corresponding to a user utterance sensed through the microphone 1320. The client module 1351 may transmit the received voice input to the intelligent server 1400. The client module 1351 may transmit state information of the user terminal 1300 together with the received voice input to the intelligent server 1400. The state information may be, for example, execution state information of an app.

The client module 1351 according to an embodiment may receive a result corresponding to the received voice input. For example, when the intelligent server 1400 is capable of calculating a result corresponding to the received voice input, the client module 1351 may receive the result corresponding to the received voice input. The client module 1351 may display the received result on the display 1340.

The client module 1351 according to an embodiment may receive a plan corresponding to the received voice input. The client module 1351 may display results of executing a plurality of actions of an app according to the plan on the display 1340. The client module 1351 may, for example, sequentially display the results of executing the plurality of actions on the display 1340. In another example, the user terminal 1300 may display only a portion of the results (e.g., a result of the last action) of executing the plurality of actions, on the display 1340.

According to an embodiment, the client module 1351 may receive a request to obtain information necessary to calculate the result corresponding to the voice input from the intelligent server 1400. According to an embodiment, the client module 1351 may transmit the necessary information to the intelligent server 1400 in response to the request.

The client module 1351 according to an embodiment may transmit information on the results of executing the plurality of actions according to the plan to the intelligent server 1400. The intelligent server 1400 may identify that the received voice input is correctly processed, based on the information on the results.

The client module 1351 according to an embodiment may include a speech recognition module. According to an embodiment, the client module 1351 may recognize a voice input to perform a limited function, through the speech recognition module. For example, the client module 1351 may execute an intelligent app for processing a voice input to perform an organic operation through a designated input (e.g., Wake up!).

The intelligent server 1400 according to an embodiment may receive information related to a user voice input from the user terminal 1300 through a communication network. According to an embodiment, the intelligent server 1400 may change data related to the received voice input to text data. According to an embodiment, the intelligent server 1400 may generate a plan for performing a task corresponding to the user voice input based on the text data.

According to an embodiment, the plan may be generated by an AI system. The AI system may be a rule-based system or a neural network-based system (e.g., a feedforward neural network (FNN) or a recurrent neural network (RNN)). Alternatively, the AI system may be a combination of the above-described systems or other AI systems. According to an embodiment, the plan may be selected from a set of pre-defined plans or may be generated in real time in response to a user request. For example, the AI system may select at least one plan from the pre-defined plans.

The intelligent server 1400 according to an embodiment may transmit a result according to the generated plan to the user terminal 1300 or transmit the generated plan to the user terminal 1300. According to an embodiment, the user terminal 1300 may display the result according to the plan on a display. According to an embodiment, the user terminal 1300 may display a result of executing an action according to the plan on the display.

The intelligent server 1400 according to an embodiment may include a front end 1410, a natural language platform 1420, a capsule database (DB) 1430, an execution engine 1440, an end user interface 1450, a management platform 1460, a big data platform 1470, or an analytic platform 1480.

The front end 1410 according to an embodiment may receive the received voice input from the user terminal 1300. The front end 1410 may transmit a response corresponding to the voice input.

According to an embodiment, the natural language platform 1420 may include ASR module 1421, an NLU module 1423, a planner module 1425, an NLG module 1427, or a TTS module 1429.

The ASR module 1421 according to an embodiment may convert the voice input received from the user terminal 1300 into text data. The NLU module 1423 according to an embodiment may discern an intent of a user, using the text data of the voice input. For example, the NLU module 1423 may discern the intent of the user by performing syntactic analysis or semantic analysis. The NLU module 1423 according to an embodiment may discern the meaning of a word extracted from the voice input using a linguistic feature (e.g., a grammatical element) of a morpheme or a phrase, and may determine the intent of the user by matching the discerned meaning of the word to an intent.

The planner module 1425 according to an embodiment may generate a plan using a parameter and the intent determined by the NLU module 1423. According to an embodiment, the planner module 1425 may determine a plurality of domains required to perform a task based on the determined intent. The planner module 1425 may determine a plurality of actions included in each of the plurality of domains determined based on the intent. According to an embodiment, the planner module 1425 may determine a parameter required to execute the determined plurality of actions, or a result value output by the execution of the plurality of actions. The parameter, and the result value may be defined as a concept of a designated form (or class). Accordingly, the plan may include a plurality of actions and a plurality of concepts determined by the intent of the user. The planner module 1425 may determine relationships between the plurality of actions and the plurality of concepts stepwise (or hierarchically). For example, the planner module 1425 may determine an execution order of the plurality of actions determined based on the intent of the user, based on the plurality of concepts. In other words, the planner module 1425 may determine the execution order of the plurality of actions based on the parameter required for the execution of the plurality of actions and results output by the execution of the plurality of actions. Accordingly, the planner module 1425 may generate a plan including connection information (e.g., ontology) on connections between the plurality of actions and the plurality of concepts. The planner module 1425 may generate the plan using information stored in the capsule DB 1430 that stores a set of relationships between concepts and actions.

The NLG module 1427 according to an embodiment may change designated information to a text form. The information changed to the text form may be in the form of a natural language utterance. The TTS module 1429 according to an embodiment may change information in a text form to information in a speech form.

According to an embodiment, some or all of the functions of the natural language platform 1420 may be implemented in the user terminal 1300 as well.

The capsule DB 1430 may store information on the relationships between the plurality of concepts and actions corresponding to the plurality of domains. A capsule according to an embodiment may include a plurality of action objects (or action information) and concept objects (or concept information) included in the plan. According to an embodiment, the capsule DB 1430 may store a plurality of capsules in the form of a concept action network (CAN). According to an embodiment, the plurality of capsules may be stored in a function registry included in the capsule DB 1430.

The capsule DB 1430 may include a strategy registry that stores strategy information necessary for determining a plan corresponding to a voice input. The strategy information may include reference information for determining one plan when a plurality of plans corresponding to the voice input are present. According to an embodiment, the capsule DB 1430 may include a follow-up registry that stores information on follow-up actions for suggesting a follow-up action to the user in a designated situation. The follow-up action may include, for example, a follow-up utterance. According to an embodiment, the capsule DB 1430 may include a layout registry that stores layout information that is information output through the user terminal 1300. According to an embodiment, the capsule DB 1430 may include a vocabulary registry that stores vocabulary information included in capsule information. According to an embodiment, the capsule DB 1430 may include a dialog registry that stores information on a dialog (or an interaction) with a user. The capsule DB 1430 may update the stored objects through a developer tool. The developer tool may include, for example, a function editor for updating an action object or a concept object. The developer tool may include a vocabulary editor for updating a vocabulary. The developer tool may include a strategy editor for generating and recording a strategy for determining a plan. The developer tool may include a dialog editor for generating a dialog with a user. The developer tool may include a follow-up editor capable of activating a subsequent goal and editing a subsequent utterance that provides hints. The subsequent goal may be determined based on a currently configured goal, a preference of a user, or environmental conditions. In an embodiment, the capsule DB 1430 may also be implemented in the user terminal 1300. The execution engine 1440 according to an embodiment may calculate a result using the generated plan. The end user interface 1450 may transmit the calculated result to the user terminal 1300. Accordingly, the user terminal 1300 may receive the result and provide the received result to the user. The management platform 1460 according to an embodiment may manage information used in the intelligent server 1400. The big data platform 1470 according to an embodiment may collect data of the user. The analytic platform 1480 according to an embodiment may manage a quality of service (QOS) of the intelligent server 1400. For example, the analytic platform 1480 may manage the components and processing rate (or efficiency) of the intelligent server 1400.

The service server 1500 according to an embodiment may provide a designated service (e.g., food order or hotel reservation) to the user terminal 1300. According to an embodiment, the service server 1500 may be a server operated by a third party. The service server 1500 according to an embodiment may provide information used to generate a plan corresponding to the received voice input to the intelligent server 1400. The provided information may be stored in the capsule DB 1430. In addition, the service server 1500 may provide result information according to the plan to the intelligent server 1400.

In the integrated intelligence system described above, the user terminal 1300 may provide various intelligent services to the user in response to a user input. The user input may include, for example, an input through a physical button, a touch input, or a voice input.

In an embodiment, the user terminal 1300 may provide a speech recognition service through an intelligent app (or a speech recognition app) stored therein. In this case, for example, the user terminal 1300 may recognize a user utterance or a voice input received through the microphone 1320 and provide a service corresponding to the recognized voice input to the user.

In an embodiment, the user terminal 1300 may perform a designated action alone or together with the intelligent server and/or service server, based on the received voice input. For example, the user terminal 1300 may execute an app corresponding to the received voice input and perform a designated action through the executed app.

In an embodiment, when the user terminal 1300 provides a service together with the intelligent server 1400 and/or the service server, the user terminal 1300 may detect a user utterance using the microphone 1320 and generate a signal (or voice data) corresponding to the detected user utterance. The user terminal 1300 may transmit the voice data to the intelligent server 1400 using the communication interface 1310.

The intelligent server 1400 according to an embodiment may generate, as a response to the voice input received from the user terminal 1300, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may be defined as parameters that are input for execution of the plurality of actions or result values that are output by execution of the plurality of actions. The plan may include connection information on connections between the plurality of actions and the plurality of concepts.

The user terminal 1300 according to an embodiment may receive the response using the communication interface 1310. The user terminal 1300 may output a voice signal generated in the user terminal 1300 to the outside using the speaker 1330, or output an image generated in the user terminal 1300 to the outside using the display 1340.

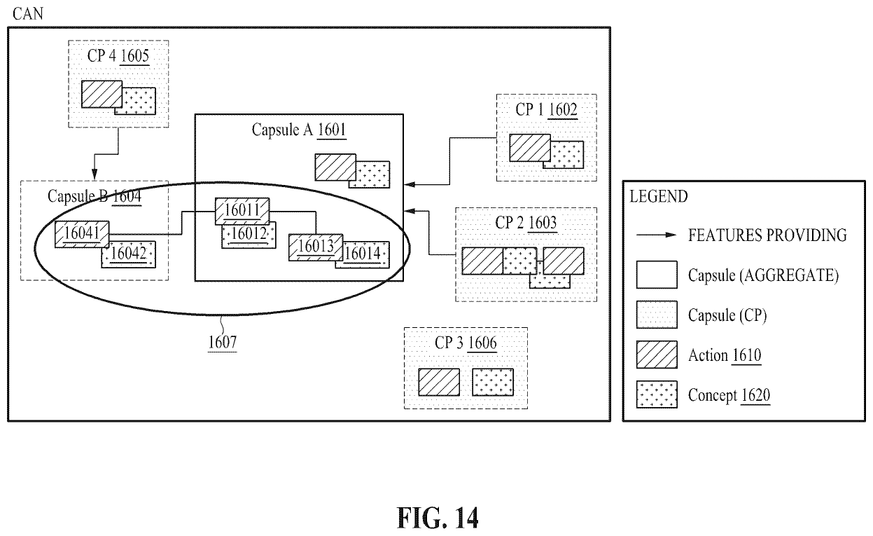

FIG. 14 is a diagram illustrating a form in which information on a relationship between concepts and actions is stored in a DB according to an embodiment.

Referring to FIG. 14, a capsule DB (e.g., the capsule DB 1430) of the intelligent server 1400 may store capsules in the form of a CAN. The capsule DB may store an action for processing a task corresponding to a voice input of a user and a parameter necessary for the action in the form of a CAN.

The capsule DB may store a plurality of capsules (e.g., a capsule A 1601 and a capsule B 1604) respectively corresponding to a plurality of domains (e.g., applications). According to an embodiment, one capsule (e.g., the capsule A 1601) may correspond to one domain (e.g., a location (geo) or an application). In addition, the one capsule may correspond to at least one service provider (e.g., CP 1 1602 or CP 2 1603) for performing a function for a domain related to the capsule. According to an embodiment, one capsule may include at least one action 1610 and at least one concept 1620 to perform a designated function.

The natural language platform 1420 may generate a plan for performing a task corresponding to the received voice input using the capsules stored in the capsule DB. For example, a planner module 1425 of the natural language platform 1420 may generate a plan using the capsules stored in the capsule DB. For example, a plan 1607 may be generated, using actions 16011 and 16013 and concepts 16012 and 16014 of the capsule A 1601, and an action 16041 and a concept 16042 of the capsule B 1604.

According to an embodiment, an electronic device may include a memory, and a processor. The processor may be configured to generate an AI agent that operates in common in a communal space and determine a domain in the AI agent, when a communal space event occurs, load the determined domain, collect user information about a user participating in the communal space event, and process an utterance of the user based on the determined domain and the user information. The AI agent may be trained, and used as discussed herein.

According to an embodiment, the processor may be configured to determine the domain corresponding to a result obtained by analyzing a name, a theme, or a description of the communal space, when determining the domain.

According to an embodiment, the processor may be configured to receive domain information selected by a user generating the communal space event and determine the domain, when determining the domain.

According to an embodiment, the processor may be configured to apply at least one model corresponding to the determined domain to at least one of an ASR module, an NLU module, an NLG module, a TTS module, or an image processing module.

According to an embodiment, the processor may be configured to transmit an invitation message to at least one user participating in the communal space event, send a request for information necessary for the communal space event to the at least one user participating in the communal space event, receive user information about each of the at least one user participating in the communal space event from each of the at least one user.

According to an embodiment, the user information may include at least one of public data of the user that is data allowed to be disclosed to other users in the communal space, private data of the user that is data that is not allowed to be disclosed to the other users in the communal space, shared data that is data related to the other users in the communal space, and personal data that is data unrelated to the other users in the communal space.

According to an embodiment, the processor may be configured to, when the user participating in the communal space event leaves the communal space before the communal space event ends, provide the user who left the communal space with history information organized up to a point in time at which the user left the communal space.

According to an embodiment, the processor may be configured to, when the user participating in the communal space event leaves the communal space before the communal space event ends, provide the user who left the communal space with history information organized up to an end point of the communal space event after the communal space event ends.

In an embodiment, the processor may be configured to, when the communal space event ends, provide each of all users participating in the communal space event with history information organized up to an end point of the communal space event after the communal space event ends.

According to an embodiment, the processor may be configured to, when the communal space event ends, classify history information organized up to an end point of the communal space event after the communal space event ends into shared data and private data, and configured to provide the shared data and the personal data corresponding to each of all users participating in the communal space event to each of all the users.

According to an embodiment, the processor may be configured to, when an occurrence of a domain addition event is detected, identify at least one model corresponding to a domain requested to be added in response to the domain addition event, and configured to additionally apply at least one model corresponding to the requested domain to at least one of an ASR module, an NLU module, an NLG module, a TTS module, or an image processing module, or replace a currently applied domain with the requested domain and apply the requested domain.

According to an embodiment, the processor may be configured to, when processing of an input of the user using a currently applied domain is impossible during analyzing and processing of the input of the user, search for a domain corresponding to the input of the user, and configured to trigger an occurrence of the domain addition event for requesting an addition of the found domain or a replacement with the found domain.

According to an embodiment, the processor may be configured to, when a request for an addition of a new domain or a replacement with the new domain is received from the user, trigger an occurrence of the domain addition event for requesting the addition of the new domain or the replacement with the new domain.

According to an embodiment, a method of operating an AI agent may include generating an AI agent that operates in common in a communal space, when a communal space event occurs, determining a domain in the AI agent, loading the determined domain, collecting user information about a user participating in the communal space event, and processing an utterance of the user based on the determined domain and the user information.

According to an embodiment, the determining of the domain may include determining the domain corresponding to a result obtained by analyzing a name, a theme, or a description of the communal space.

According to an embodiment, the determining of the domain may include receiving domain information selected by a user generating the communal space event, and determining the domain.

According to an embodiment, the loading of the determined domain may include applying at least one model corresponding to the determined domain to at least one of an ASR module, an NLU module, an NLG module, a TTS module, or an image processing module.

According to an embodiment, the collecting of the user information about the user participating in the communal space event may include transmitting an invitation message to at least one user participating in the communal space event, sending a request for information necessary for the communal space event to the at least one user participating in the communal space event, and receiving user information about each of the at least one user participating in the communal space event from each of the at least one user.

According to an embodiment, the user information may include at least one of public data of the user that is data allowed to be disclosed to other users in the communal space, private data of the user that is data that is not allowed to be disclosed to the other users in the communal space, shared data that is data related to the other users in the communal space, and personal data that is data unrelated to the other users in the communal space.

According to an embodiment, the method of operating the AI agent may further include, when the user participating in the communal space event leaves the communal space before the communal space event ends, providing the user who left the communal space with history information organized up to a point in time at which the user left the communal space.

According to an embodiment, the method of operating the AI agent may further include, when the user participating in the communal space event leaves the communal space before the communal space event ends, providing the user who left the communal space with history information organized up to an end point of the communal space event after the communal space event ends.

According to an embodiment, the method of operating the AI agent may further include, when the communal space event ends, providing each of all users participating in the communal space event with history information organized up to an end point of the communal space event after the communal space event ends.

According to an embodiment, the providing of each of all the users participating in the communal space event with the history information organized up to the end point of the communal space event after the communal space event ends, when the communal space event ends may include, when the communal space event ends, classifying the history information organized up to an end point of the communal space event after the communal space event ends into shared data and private data, and providing the shared data and the personal data corresponding to each of all the users participating in the communal space event to each of all the users.

According to an embodiment, the method of operating the AI agent may further include detecting an occurrence of a domain addition event, identifying at least one model corresponding to a domain requested to be added in response to the domain addition event, and additionally applying at least one model corresponding to the requested domain to at least one of an at least one of an ASR module, an NLU module, an NLG module, a TTS module, or an image processing module, or replacing a currently applied domain with the requested domain and applying the requested domain.

According to an embodiment, the detecting of the occurrence of the domain addition event may include, when processing of an input of the user using a currently applied domain is impossible during analyzing and processing of the input of the user, searching for a domain corresponding to the input of the user, and triggering an occurrence of the domain addition event for requesting an addition of the found domain or a replacement with the found domain.

According to an embodiment, the detecting of the occurrence of the domain addition event may include receiving a request for an addition of a new domain or a replacement with the new domain from the user, and triggering an occurrence of the domain addition event for requesting the addition of the new domain or the replacement with the new domain.

The methods according to the embodiments described herein may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to one of ordinary skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The above-described hardware devices may be configured to act as one or more software modules in order to perform the operations of the embodiments, or vice versa.

The software may include a computer program, a piece of code, an instruction, or one or more combinations thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

Therefore, other implementations, other embodiments, and equivalents to the claims are also within the scope of the following claims.

What is claimed is:

1. An electronic device comprising:
a memory; and
at least one processor, comprising processing circuitry, individually and/or collectively configured to:
generate an artificial intelligence (AI) agent configured to operate in common in a communal space and determine a domain in the AI agent, when a communal space event occurs;
load the determined domain;
collect user information about a user participating in the communal space event; and
process an utterance of the user based on the determined domain and the user information.

2. The electronic device of claim 1, wherein at least one processor, comprising processing circuitry, is individually and/or collectively configured to determine at least one of the domain corresponding to a result obtained by analyzing a name, a theme, or a description of the communal space, when determining the domain.

3. The electronic device of claim 1, wherein at least one processor, comprising processing circuitry, is individually and/or collectively configured to receive domain information selected by a user generating the communal space event and determine the domain, when determining the domain.

4. The electronic device of claim 1, wherein at least one processor, comprising processing circuitry, is individually and/or collectively configured to apply at least one model corresponding to the determined domain to at least one of an automatic speech recognition (ASR) module, a natural language understanding (NLU) module, a natural language generator (NLG) module, a text-to-speech (TTS) module, or an image processing module, when loading the determined domain.

5. The electronic device of claim 1, wherein at least one processor, comprising processing circuitry, is individually and/or collectively configured to:
transmit an invitation message to at least one user participating in the shared space event;
send a request for information necessary for the communal space event to the at least one user participating in the communal space event;
receive user information about each of the at least one user participating in the communal space event from each of the at least one user; and
collect the user information.

6. The electronic device of claim 1, wherein the user information comprises at least one of:
public data of the user that is data allowed to be disclosed to other users in the communal space;
private data of the user that is data that is not allowed to be disclosed to the other users in the communal space;
shared data that is data related to the other users in the communal space; and
personal data that is data unrelated to the other users in the communal space.

7. The electronic device of claim 1, wherein at least one processor, comprising processing circuitry, is individually and/or collectively configured to, when the user participating in the communal space event leaves the communal space before the communal space event ends, provide the user who left the communal space with history information organized up to a point in time at which the user left the communal space.

8. The electronic device of claim 1, wherein at least one processor, comprising processing circuitry, is individually and/or collectively configured to, when the user participating in the communal space event leaves the communal space before the communal space event ends, provide the user who left the communal space with history information organized up to an end point of the communal space event after the communal space event ends.

9. The electronic device of claim 1, wherein at least one processor, comprising processing circuitry, is individually and/or collectively configured to, when the communal space event ends, provide each of all users participating in the communal space event with history information organized up to an end point of the communal space event after the communal space event ends.

10. The electronic device of claim 1, wherein at least one processor, comprising processing circuitry, is individually and/or collectively configured to:
when the communal space event ends, classify history information organized up to an end point of the communal space event after the communal space event ends into shared data and private data; and
provide the shared data and the personal data corresponding to each of all users participating in the communal space event to each of all the users.

11. The electronic device of claim 1, wherein at least one processor, comprising processing circuitry, is individually and/or collectively configured to:
when an occurrence of a domain addition event is detected, identify at least one model corresponding to a domain requested to be added in response to the domain addition event; and
additionally apply at least one model corresponding to the requested domain to at least one of an ASR module, an NLU module, an NLG module, a TTS module, or an image processing module, or replace a currently applied domain with the requested domain and apply the requested domain.

12. The electronic device of claim 1, wherein at least one processor, comprising processing circuitry, is individually and/or collectively configured to:
when processing of an input of the user using a currently applied domain is impossible during analyzing and processing of the input of the user, search for a domain corresponding to the input of the user; and
trigger an occurrence of the domain addition event for requesting an addition of the found domain or a replacement with the found domain.

13. The electronic device of claim 1, wherein at least one processor, comprising processing circuitry, is individually and/or collectively configured to, when a request for an addition of a new domain and/or a replacement with the new domain is received from the user, trigger an occurrence of the domain addition event for requesting the addition of the new domain or the replacement with the new domain.

14. A method of operating an artificial intelligence (AI) agent, the method comprising:
generating an AI agent that operates in common in a communal space, when a communal space event occurs;
determining a domain in the AI agent;
loading the determined domain;
collecting user information about a user participating in the communal space event; and
processing an utterance of the user based on the determined domain and the user information.

15. The method of claim 14, wherein the determining of the domain comprises at least one of determining the domain corresponding to a result obtained by analyzing a name, a theme, or a description of the communal space.

16. The method of claim 14, further comprising:
when the user participating in the communal space event leaves the communal space before the communal space event ends, providing the user who left the communal space with history information organized up to a point in time at which the user left the communal space.

17. The method of claim 14, further comprising:
when the user participating in the communal space event leaves the communal space before the communal space event ends, providing the user who left the communal space with history information organized up to an end point of the communal space event after the communal space event ends.

18. The method of claim 14, further comprising:
when the communal space event ends, providing each of all users participating in the communal space event with history information organized up to an end point of the communal space event after the communal space event ends.

19. The method of claim 14, further comprising:
detecting an occurrence of a domain addition event;
identifying at least one model corresponding to a domain requested to be added in response to the domain addition event; and
additionally applying at least one model corresponding to the requested domain to at least one of an at least one of an automatic speech recognition (ASR) module, a natural language understanding (NLU) module, a natural language generator (NLG) module, a text-to-speech (TTS) module, or an image processing module, or replacing a currently applied domain with the requested domain and applying the requested domain.

20. A non-transitory computer-readable storage medium storing instructions that, when executed by a processor, cause the processor to perform the method of claim 14.
